(19) United States
(12) Patent Application Publication
(10) Pub. No.: US 2019/0096066 A1
(43) Pub. Date: Mar. 28, 2019

(54) System and Method for Segmenting Out Multiple Body Parts

(71) Applicant: 4Sense, Inc., Delray Beach, FL (US)

(72) Inventor: Hai-Wen Chen, Lake Worth, FL (US)

(73) Assignee: 4Sense, Inc., Delray Beach, FL (US)

(21) Appl. No.: 15/718,777

(22) Filed: Sep. 28, 2017

(51) Int. Cl. G06T 7/136; G06T 7/246; G06K 9/00; G06T 7/10

(52) U.S. Cl. CPC G06T 7/136; G06T 7/246; G06K 9/00362; G06T 2207/10024; G06T 2207/10016; G06T 2207/30196; G06T 7/10

(57) ABSTRACT

A system for segmenting out multiple body parts of an image is described herein. The system can include an image-sensor circuit configured to generate a frame of a monitoring area that includes data associated with a human target in the monitoring area. The system can also include a processor communicatively coupled to the image-sensor circuit. The processor can be configured to receive the frame from the image-sensor circuit and compare spectral angles extracted from the frame with multiple reference spectral angles corresponding to different body parts associated with the human target. The processor can also be configured to segment out multiple body parts associated with the human target based on the comparison of the spectral angles extracted from the frame with the reference spectral angles.

### FIELD

The subject matter described herein relates to computer vision systems and more particularly, to computer-vision systems configured for segmenting images.

### BACKGROUND

In some computer-vision systems, an object in an image may be segmented out to enable a number of functions to be performed. For example, a grouping of pixels associated with a human may be isolated from the pixels related to the rest of the image. This collection of pixels is sometimes referred to as a full-body segmentation. Certain parameters, such as a centroid and a bounding box, may be estimated for the full-body segmentation. Because the full-body segmentation typically corresponds to a human body, the estimated parameters may enable the human to be tracked. Because humans may mingle together, the tracking system can mistakenly estimate a single centroid for two separate full-body segmentations if the human targets overlap or stand close to one another. In this case, the tracking of one or both the targets may be interrupted.

### SUMMARY

A system for segmenting out multiple body parts of an image is described herein. The system can include an image-sensor circuit configured to generate a frame of a monitoring area that includes data associated with a human target in the monitoring area. The system can also include a processor communicatively coupled to the image-sensor circuit. The processor can be configured to receive the frame from the image-sensor circuit, compare spectral angles extracted from the frame with multiple reference spectral angles corresponding to different body parts associated with the human target, and based on the comparison of the spectral angles extracted from the frame with the reference spectral angles, segment out multiple body parts associated with the human target.

The processor can be further configured to estimate one or more detection fields for the body parts that are segmented out, and at least one of the detection fields can be a body-part centroid. The processor can be further configured to determine whether the body parts that are segmented out are related to one another. In addition, the processor can be configured to estimate a virtual centroid based on one or more of the body-part centroids when the body parts that are segmented out are related to one another and track the human target based on the virtual centroid. The processor can also be configured to classify one or more of the body parts that are segmented out in accordance with a classification scheme.

In one embodiment, the processor can be configured to estimate the reference spectral angles corresponding to the different body parts associated with the human target. Additionally, the processor can be configured to compare an estimated reference spectral angle corresponding to a first body part with an estimated reference spectral angle corresponding to a second body part. The processor can be configured to—when a difference between the reference spectral angle corresponding to the first body part and the reference spectral angle corresponding to the second body part has a value that is below or equal to a threshold—discount the reference spectral angle for the first body part when the processor compares the spectral angles of the frame with the reference spectral angles corresponding to the different body parts associated with the human target. As an example, the first body part may be an upper body part, and the second body part may be a lower body part.

As another example, the processor can be configured to—when the reference spectral angle for the first body part is discounted—generate a substitute first body part by inverting the second body part. In addition, the processor can be configured to estimate a virtual centroid for tracking based at least on a body-part centroid of the second body part and a body-part centroid of the substitute first body part.

A segmentation system is also described herein. The system can include an image-sensor circuit configured to generate a frame of a monitoring area that includes data associated with an object in the monitoring area. The system can also include a processor communicatively coupled to the image-sensor circuit. The processor can be configured to receive the frame from the image-sensor circuit and compare spectral angles corresponding to a full-body segmentation of the frame with multiple reference spectral angles corresponding to different parts of the object. The processor can be further configured to—based on the comparison of the spectral angles corresponding to the full-body segmentation of the frame with the reference spectral angles—segment out multiple parts from the full-body segmentation, wherein the multiple parts that are segmented out and the full-body segmentation are associated with the object.

As an example, the object can be a human target, and the multiple parts that are segmented out from the full-body segmentation can be body parts associated with the human target. As another example, the body parts that may be segmented out from the full-body segmentation can include an upper-body part, a lower-body part, a skin part, and a hair part. Moreover, the processor can be configured to estimate a reference spectral angle for the upper-body part, the lower-body part, the skin part, and the hair part. The skin part may include one or more skin parts. The processor can be further configured to discard values of the pixels associated with at least some of the skin parts when estimating the reference spectral angles for the upper body part, the lower body part, or the hair part.

The processor can also be configured to compare the reference spectral angle for the upper-body part with the reference spectral angle for the lower-body part and—when the reference spectral angle for the upper-body part has a value that is below a difference threshold in comparison to a value of the reference spectral angle for the lower-body part—bypass the use of the reference spectral angle for the upper-body part for segmenting out body parts from the full-body segmentation. The processor can be further configured to estimate a body-part centroid for the body parts that are segmented out, estimate a virtual centroid based on the body-part centroids, and track the human target based on the virtual centroid.

A method for decomposing a full-body segmentation into multiple body-part segmentations is also described herein. The method can include the steps of realizing a full-body segmentation associated with a human target and comparing spectral angles corresponding to the full-body segmentation with multiple reference spectral angles corresponding to different portions of the human target. Based on comparing the spectral angles corresponding to the full-body segmentation with the multiple reference spectral angles, multiple body parts can be segmented out from the full-body segmentation. The method can also include the steps of estimating a virtual centroid based on the body parts segmented out from the full-body segmentation and using the virtual centroid to track the human target.

As an example, the body parts segmented out from the full-body segmentation can include an upper-body part, a lower-body part, and a hair part. The method can also include the step of estimating a reference spectral angle for the upper-body part, the lower-body part, and the hair part. Skin parts may also be segmented out from the full-body segmentation, and reference spectral angles may be estimated for them.

In one embodiment, the step of estimating the virtual centroid based on the body parts segmented out from the full-body segmentation can include estimating the virtual centroid based on both an upper-body part and a lower-body part or estimating the virtual centroid based on both the lower-body part and an inverted lower-body part. As an example, estimating the virtual centroid based on both the lower-body part and an inverted lower-body part can include estimating the virtual centroid based on both the lower-body part and the inverted lower-body part when a value for the reference spectral angle for the upper-body part is below a difference threshold in comparison to a value for the reference spectral angle for the lower-body part.

### BRIEF DESCRIPTION OF THE DRAWINGS

FIG. 1 illustrates a block diagram of an example of a system for segmenting out multiple body parts.

FIG. 2 illustrates an example of a monitoring area.

FIG. 3 illustrates an example of a method for segmenting out multiple body parts.

FIG. 4 illustrates an example of several full-body detections that are part of a red-green-blue (RGB) frame in which the full-body detections are related to multiple targets.

FIG. 5 illustrates an example of several full-body segmentations that are part of an RGB frame.

FIG. 6 illustrates an example of several full-body segmentations and body parts that are part of an RGB frame.

FIG. 7 illustrates an example of two full-body detections that are part of an RGB frame and that represent two different targets in which one of the targets has moved in front of the other.

FIG. 8 illustrates an example of two full-body detections with virtual centroids that are part of an RGB frame and that represent two different targets in which one of the targets has moved in front of the other.

FIG. 9 illustrates an example of an image with a full-body segmentation that represents a person that is part of the image.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously mentioned, a computer-vision system can segment out a full-body segmentation to enable a human to be tracked. Unfortunately, the system may confuse two separate targets as a single target, which will cause a disruption in the tracking for one or both of them.

As a solution, a system for segmenting out multiple body parts of an image is described herein. The system can include an image-sensor circuit configured to generate a frame of a monitoring area that includes data associated with a human target in the monitoring area. The system can also include a processor communicatively coupled to the image-sensor circuit. The processor can be configured to receive the frame from the image-sensor circuit and compare spectral angles extracted from the frame with multiple reference spectral angles corresponding to different body parts associated with the human target. The processor can also be configured to segment out multiple body parts associated with the human target based on the comparison of the spectral angles extracted from the frame with the reference spectral angles. As an example, the body parts that are segmented out may be associated with a full-body segmentation of the human target.

Because the system can segment out multiple body parts from a full-body segmentation that is associated with a human target, it can improve computer-vision technology in several ways. For example, data associated with the body parts can improve the tracking of multiple targets and the pose estimations of such targets.

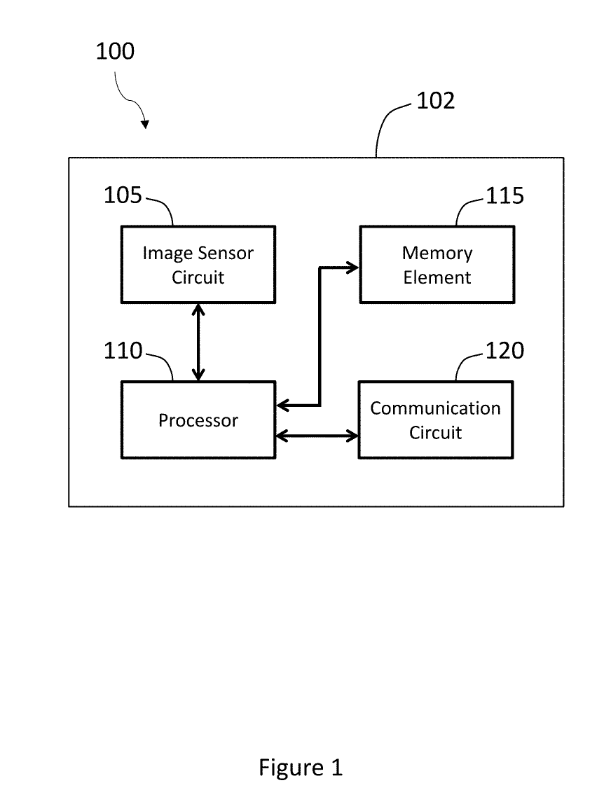

Detailed embodiments are disclosed herein; however, they are intended to be exemplary. Therefore, specific structural and functional details disclosed herein are not to be interpreted as limiting, as they merely serve as a basis for the claims and for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structures or applications.

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or originating or reflected from a living being, composition, machine, etc. or are otherwise sensitive to variations in one or more phenomena associated with such living being, composition, machine, etc. and provide some signal or output that is proportional or related to the stimuli or the variations. An “image-sensor circuit” is defined as a sensor that receives and is sensitive to at least visible light and generates signals for creating images, or frames, based off the received visible light. An “object” is defined as any real-world, physical object or one or more phenomena that results from or exists because of the physical object, which may or may not have mass. An example of an object with no mass is a human shadow. A “target” is defined as an object or a representation of an object that is being, is intended to be, or is capable of being passively tracked. Examples of targets include humans, animals, or machines. The term “monitoring area” is an area or portion of an area, whether indoors, outdoors, or both, that is observed or monitored by one or more sensors.

A “frame” (or “image”) is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object (or a target) or the presence of visible light in a monitoring area or other location.

A “processor” is defined as a circuit-based component or group of circuit-based components that are configured to execute instructions or are programmed with instructions for execution (or both) to carry out the processes described herein, and examples include single and multi-core processors and co-processors. The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols. The term “digitally detect” is defined as to detect by a machine in digital form or in a digital environment or setting.

The term “communicatively coupled” is defined as a state in which signals may be exchanged between or among different circuit-based components, either on a unidirectional or bidirectional basis, and includes direct or indirect connections, including wired or wireless connections. A “hub” is defined as a circuit-based component in a network that is configured to exchange data with one or more passive-tracking systems or other nodes or components that are part of the network and is responsible for performing some centralized processing or analytical functions with respect to the data received from the passive-tracking systems or other nodes or components.

A “camera” is defined as an instrument for capturing images and operates in the visible-light spectrum, the non-visible-light spectrum, or both. A “red-green-blue camera” or an “RGB camera” is defined as a camera whose operation is based on the principle of the visible red-blue-green (RGB) color spectrum in which red, green, and blue light are added together in various ways to form a broad array of colors. A “pixel” is defined as the smallest addressable element in an image. A “color pixel” is defined as a pixel based on a combination of one or more colors.

The term “digital representation” is defined as a representation of an object (or target) in which the representation is in digital form or otherwise is capable of being processed by a computer. A “human-recognition feature” is defined as a feature, parameter, or value that is indicative or suggestive of a human or some portion of a human. Similarly, a “living-being-recognition feature” is defined as a feature, parameter, or value that is indicative or suggestive of a living being or some portion of a living being. The word “skin” is defined as tissue that forms the natural outer covering of the body of a person or animal. The term “exposed skin” is defined as skin that is uncovered, such as by a garment or a blanket.

A “detection” is defined as a representation of an object (or target) and is attached with or includes data related to one or more characteristics of the object (or target). A detection may exist in digital or visual form (or both). A “full-body detection” is defined as a detection that represents an object (or target) in its entirety or its intended entirety. A “false detection” is defined as a detection that does not correspond to a target or is not intended to be or is not capable of being tracked. A “segmentation” is defined as a grouping of pixels or other discrete elements that are isolated from other pixels or elements based on some common characteristic, quality, or value. An example of a common characteristic, quality, or value are equal or substantially equal spectral angles. A “full-body segmentation” is defined as a segmentation that is associated with an object (or target) in its entirety or its intended entirety. A “body part” or “body-part segmentation” is defined as a segmentation that is a discrete part of a full-body segmentation. The terms “segment out” or “segmenting out” are defined as to detect, recognize, identify, discover, discern, distinguish, perceive, isolate, or ascertain a body in comparison to a larger body, whether the body is part of the larger body or not. The term “detection data” is defined as data that is related to one or more characteristics of a detection or some other element, including the dimensions, size, content, motion, orientation, position, or classification of the detection or element.

The term “color vector” is defined as a vector whose direction is determined by the color of the object (or target) with which the vector is associated, such as by a color pixel corresponding to the object (or target). The term “reference spectral angle” is defined as a spectral angle based on a collective RGB value against which the spectral angles of pixels or other elements are compared. The term “skin reference spectral angle” is defined as a reference spectral angle in which the collective RGB value is based on pixels or other elements associated with the skin of one or more targets. A “threshold” is defined as a value, parameter, condition, point, or level used for comparative purposes.

The term “three-dimensional position” is defined as data that provides in three dimensions the position of an element in some setting, including real-world settings or computerized settings. The term “two-dimensional position” is defined as data that provides in two dimensions the position of an element in some setting, including real-world settings or computerized settings. The term “periodically” is defined as recurring at regular or irregular intervals or a combination of both regular and irregular intervals. The term “confidence factor” is defined as one or more values or other parameters that are attached or assigned to data related to a measurement, calculation, analysis, determination, finding, or conclusion and that provide an indication as to the likelihood, whether estimated or verified, that such data is accurate or plausible.

The word “generate” or “generating” is defined as to bring into existence or otherwise cause to be. The word “distinguish” or “distinguishing” is defined as to recognize as distinct or different or to set apart or identify as distinct or different. The word “estimate” or “estimating” is defined as to approximately or accurately calculate or otherwise obtain or retrieve one or more values. The word “compare” or “comparing” is defined as to estimate, measure, determine, or record the similarity or dissimilarity (or both) between one or more objects, values, parameters, events, or criterion. The word “extract” or “extracting” is defined as to obtain, get, retrieve, acquire, receive, or remove. The word “classify” or “classifying” is defined as to assign, determine, designate, label, arrange, order, sort, rank, rate, group, or categorize. The word “discard” or “discarding” is defined as to reject, ignore, throw out, discount, or subtract out. The word “invert” or “inverting” is defined as to place, position, locate, arrange, or situate in an opposite or substantially opposite position, order, or arrangement, such as with respect to some reference point or plane. The word “constant” is defined as fixed or substantially fixed with deviations of plus or minus ten percent or less.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses all possible combinations of one or more of the associated listed items. As an example, the phrase “at least one of A, B and C” includes A only, B only, C only, or any combination thereof (e.g. AB, AC, BC or ABC). Additional definitions may be provided throughout this description.

Referring to FIG. 1, a block diagram of an example of a system 100 for segmenting out multiple body parts is shown. The system 100 can include one or more cameras 102. The camera 102 can include one or more image-sensor circuits 105, one or more processors 110, one or more circuit-based memory elements 115, and one or more communication circuits 120. Each of the foregoing devices of the camera 102 can be communicatively coupled to the processor 110 and to each other, where necessary. These devices may also be independent of the camera 102, such as being built into or otherwise part of some other component of the system 100, and configured to exchange signals with the camera 102. Although not pictured here, the camera 102 may also include other components to facilitate its operation, like power supplies (portable or fixed), heat sinks, displays or other visual indicators (like LEDs), speakers, and supporting circuitry.

The image-sensor circuit 105 can be any suitable component for receiving light and converting it into electrical signals for generating images (or frames). Examples include a charge-coupled device (CCD), complementary metal-oxide semiconductor (CMOS), or N-type metal-oxide semiconductor (NMOS).

The processor 110 can oversee the operation of the camera 102 and can coordinate processes between all or any number of the components of the camera 102. Any suitable architecture or design may be used for the processor 110. For example, the processor 110 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The processor 110 can include at least one hardware circuit (e.g., an integrated circuit) configured to carry out instructions contained in program code.

In arrangements in which there are multiple processors 110, such processors 110 can work independently from each other, or one or more processors 110 can work in combination with each other. In one or more arrangements, the processor 110 can be a main processor of some other device, of which the camera 102 may or may not be a part. This description about processors may apply to any other processor that may be part of any system or component described herein, including any of the individual components of the camera 102. Moreover, other components of the camera 102, irrespective of whether they are shown here, may be integrated or attached to the camera 102 as an individual unit, or they may be part of some other device or system or completely independent components.

The circuit-based memory elements 115 can be include any number of units and type of memory for storing data. As an example, a circuit-based memory element 115 may store instructions and other programs to enable any component, device, sensor, or system of the camera 102 to perform its functions. As an example, a circuit-based memory element 115 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 115 can be part of the processor 110 or can be communicatively connected to the processor 110 (and any other suitable devices) for use thereby. In addition, any of the various other parts of the camera 102 may include one or more circuit-based memory elements 115.

The communication circuit 120 can permit the camera 102 or any other component of the system 100 to exchange data with other devices, systems, or networks. The communication circuit 120 can be configured to support various type of communications, including those governed by certain protocols or standards, whether wired or wireless (or both). These communications may include local- or wide-area communications (or both). Examples of protocols or standards under which the communications circuit 120 may operate include Bluetooth, Near Field Communication, and Wi-Fi, although virtually any other specification for governing communications between or among devices and networks may govern the communications. Although the communication circuit 120 may support bi-directional exchanges between the camera 102 (or system 100) and other devices, it may be designed to only support unidirectional communications, such as only receiving or only transmitting signals. As will be shown later, the communication circuit 120 can be used to access images for processing from any suitable database.

In one arrangement, the camera 102 may be a red-green-blue (RGB) camera, meaning that it can have several bandpass filters configured to permit light with wavelengths that correspond to these colors to pass through to the image-sensor circuit 105. In a typical RGB camera, the wavelength associated with the peak value for blue is around 430 nanometers (nm), green is about 550 nm, and red is roughly 620 nm. Of course, these wavelengths, referred to as central wavelengths, may be different for some RGB cameras, and the processes described herein may be performed irrespective of their values. In addition, the RGB camera may be configured with additional bandpass filters to allow light in other spectral bands to pass, including light within and outside the visible spectrum. For example, the RGB camera may be equipped with a near infra-red bandpass filter (NIR) to enable light in that part of the spectrum to reach the image-sensor circuit 105. As an example, the NIR wavelength associated with peak value may be around 850 nm, although other wavelengths may be used.

In some cases, adjustments can be made after the initial setting of the central wavelengths. For example, the central wavelength for red may be moved from 620 nm to 650 nm, such as by placing an additional filter over the existing bandpass filter or re-programming it. In fact, the RGB camera may be reconfigured to block out light in any of the existing RGB spectral bands and may continue to provide useful data if at least two spectral bands remain. In addition, the camera 102 is not necessarily limited to an RGB camera, as the camera 102 may employ any number and combination of spectral bands for its operation. As the number of spectral bands increases, the ability of the camera 102 to detect objects may improve, although a balance should be maintained because the processing of the additional information increases the computational complexity of the camera 102, particularly if moving targets are involved.

No matter the configuration of the camera 102, the processor 110 may acquire spectral-band values from the input of the image-sensor circuit 105 that are based on the light received by the image-sensor circuit 105. The processor 110 may acquire these values by generating or determining them itself (based on the incoming signals from the image-sensor circuit 105) or receiving them directly from the image-sensor circuit 105. For example, in the case of an RGB camera, the image-sensor circuit 105 may provide the processor 110 with three RGB values for each pixel. The collection of the RGB values for the pixels may be part of an image, or frame, that represents the subject matter captured by the image-sensor circuit 105, and additional operations may be performed on this image later, as will be explained below.

In some cases, the camera 102 may be part of a network (not shown) in which the camera 102 transmits or receives (or both) data and commands with other cameras 102, systems, or devices, which can be referred to as network-based components. The network may also include one or more hubs (not shown), which may be communicatively coupled to any of the cameras 102 and any other network-based component. The hubs may process data received from the cameras 102 and network-based components and may provide the results of such processing to them or other systems. To support this data exchange, the cameras 102, the network-based components, and the hubs may be configured to support wired or wireless (or both) communications in accordance with any acceptable standards. The network-based components and the hubs may be positioned within or outside (or a combination of both) any area served by the cameras 102. As such, the network-based components and the hubs may be considered local or remote, in terms of location and being hosted, for a network.

In another embodiment, the system 100 may not include a camera 102 or an image-sensor circuit 105. In this example, the other components described above, including the processor 110, circuit-based memory element 115, and communication circuit 120, may be part of the system 100. A system 100 configured in this manner may be useful for accessing images from a database or other repository (not shown here) and analyzing the images to segment out multiple body parts. Examples of such an arrangement will be presented below.

When a camera 102 is part of the system 100, the system 100 may be configured to passively track one or more objects in an area. The term “passively track” or “passively tracking” is defined as a process in which a position of an object, over some time, is monitored, observed, recorded, traced, extrapolated, followed, plotted, or otherwise provided (whether the object moves or is stationary) without at least the object being required to carry, support, or use a device capable of exchanging signals with another device that are used to assist in determining the object's position. As an example, the camera 102 may be positioned in a monitoring area and can be configured to detect certain objects, like humans. Such humans may be referred to as human targets or simply, targets (although a target is not necessarily limited to a human). As part of this detection, the camera 102 can be configured to distinguish between different targets and to track them over time. In one arrangement, the camera 102 may be part of or independently configured as a passive-tracking system for passively tracking human targets or other objects. Additional information on such a system and its features can be found in U.S. Pat. No. 9,638,800, issued on May 2, 2017, which is herein incorporated by reference.

The system 100 can be configured to detect and track other objects, such as other living beings. Examples of other living beings include animals, like pets, service animals, animals that are part of an exhibition, etc. Although plants are not capable of movement on their own, a plant may be a living being that is detected and tracked or monitored by the system described herein, particularly if it has some significant value and may be vulnerable to theft or vandalism. An object may also be a non-living entity, such as a machine or a physical structure, like a wall or ceiling. As another example, an object may be a phenomenon that is generated by or otherwise exists because of a living being or a non-living entity, such as a shadow, disturbance in a medium (e.g., a wave, ripple or wake in a liquid), vapor, or emitted energy (like heat or light).

As noted above, the camera 102 may be assigned to a certain area, referred to as a monitoring area. As an example, a monitoring area may be an enclosed or partially enclosed space, an open setting, or any combination thereof. Examples include man-made structures, like a room, hallway, vehicle or other form of mechanized transportation, porch, open court, roof, pool or other artificial structure for holding water or some other liquid, holding cells, or greenhouses. Examples also include natural settings, like a field, natural bodies of water, nature or animal preserves, forests, hills or mountains, or caves. Examples also include combinations of both man-made structures and natural elements.

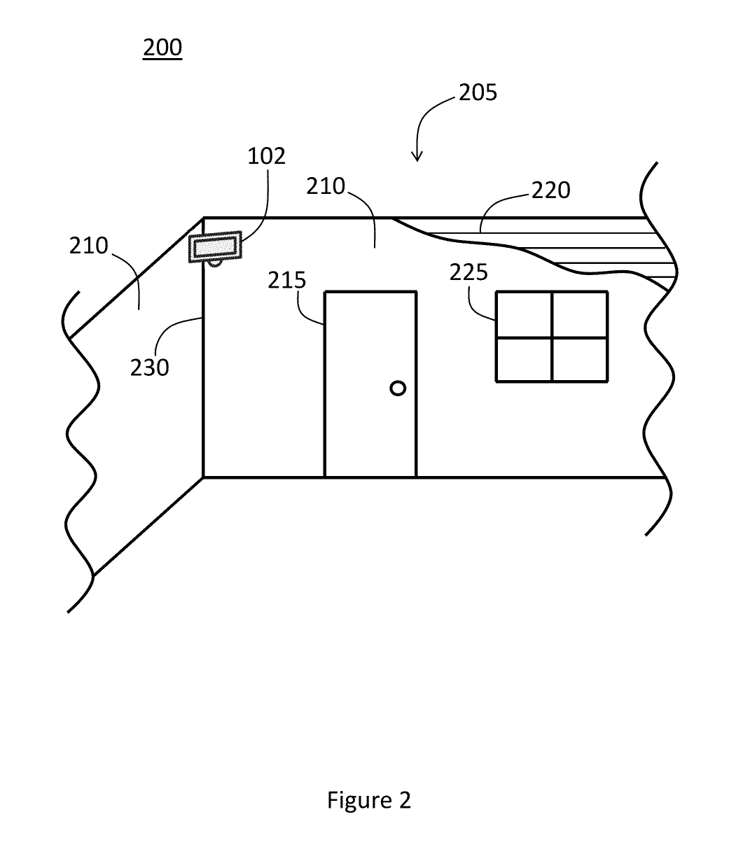

Referring to FIG. 2, an example of a monitoring area 200 in the form of an enclosed room 205 (shown in cut-away form) is presented. The room 205 may have several walls 210, an entrance 215, a ceiling 220 (also shown in cut-away form), and one or more windows 225, which may permit natural light to enter the room 205. Although coined as an entryway, the entrance 215 may be an exit or some other means of ingress and/or egress for the room 205. In one embodiment, the entrance 215 may provide access (directly or indirectly) to another monitoring area (not shown), such as an adjoining room or one connected by a hallway. In such a case, the entrance 215 may also be referred to as a portal, particularly for a logical mapping scheme. In this example, the camera 102 may be positioned in a corner 230 of the room 205 or in any other suitable location. As will be explained below, the camera 102 can be configured to detect one or more human targets that enter the monitoring area 200 and segment out multiple body parts associated with the targets.

Any number of cameras 102 may be assigned to the monitoring area 200, and a camera 102 may not necessarily be assigned to monitor a particular area, as detection and tracking could be performed for any particular setting in accordance with any number of suitable parameters. Moreover, the camera 102 may be fixed in place in or proximate to a monitoring area 200, although the camera 102 is not necessarily limited to such an arrangement. For example, one or more cameras 102 may be configured to move along a track or some other structure that supports movement or may be attached to or integrated with a machine capable of motion, like a drone, vehicle, or robot.

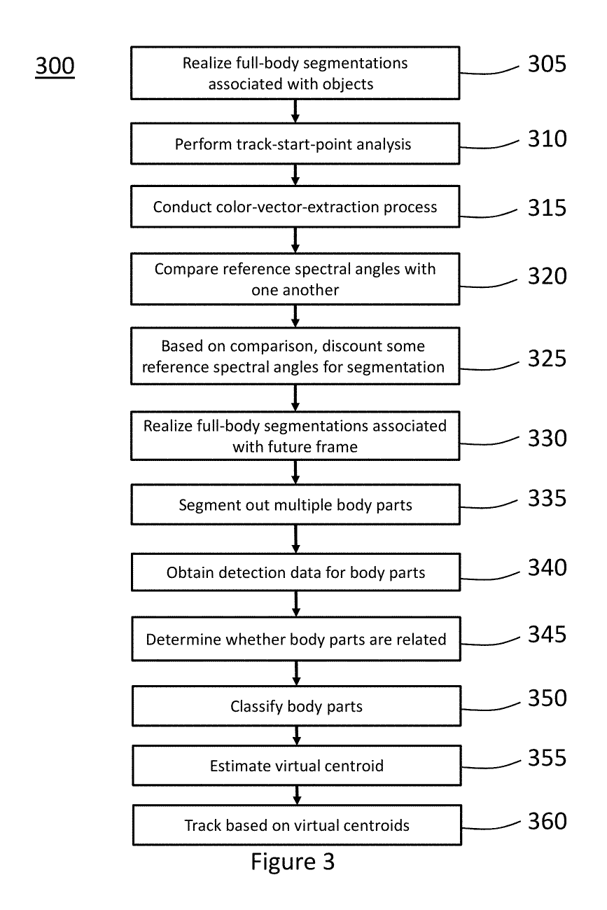

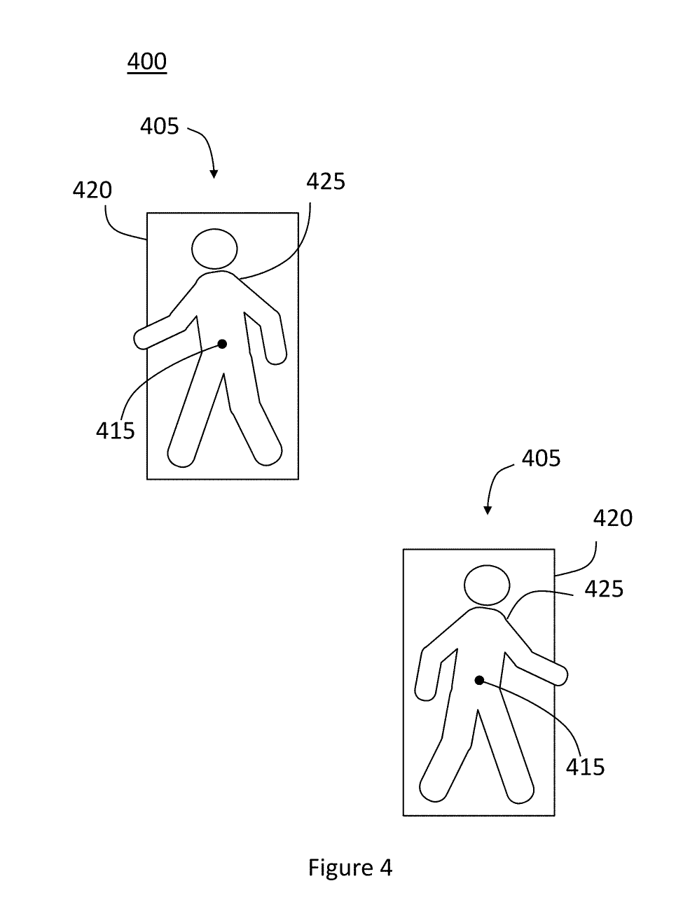

Referring to FIG. 3, an example of a method 300 for segmenting out multiple body parts is illustrated. The method 300 may include additional steps, beyond those presented here, and may not necessarily require all the steps so presented. Moreover, the method 300 is not necessarily limited to this chronological order, as any of the steps of the method 300, regardless of whether they are shown here, may be in any suitable order. To assist in the explanation of the method 300, reference may be made to FIGS. 1 and 2, although the method 300 may be practiced with other suitable devices or systems and in other settings. In addition, reference may be made to FIGS. 4-8, each of which will be presented below, to provide (non-limiting) details and context for the method 300.

Initially, at step 305, one or more full-body segmentations associated with one or more objects may be realized. In one example, the objects may be human targets, although this description may apply to non-human objects. Information on such a process can be found in U.S. patent application Ser. No. 15/597,941 (the “'941 application”), filed on May 17, 2017, and “Moving Human Full-Body and Body-Parts Detection, Tracking, and Applications on Human Activity Estimation, Walking Pattern and Face Recognition,” Hai-Wen Chen and Mike McGurr, Automatic Target Recognition XXVI, Proc. of SPIE, Vol. 9844, pages 98440T-1 to 98440T-34, published in May 2016 (referred to as the “Chen Publication” for the rest of this document), both of which are herein incorporated by reference. Nevertheless, a summary of acquiring full-body segmentations will be presented here.

When a current frame containing digital representations of the targets is received, the background clutter of the current frame can be removed (or filtered out). As an example, the current frame can be set as a reference frame, and a previous frame, which may also include digital representations of the targets, can be subtracted from the current frame to suppress static background clutter. Following the removal of the background clutter, a current RGB frame may include the RGB values related to several detections, some of which may correspond to the targets. Other detections, however, may not be related to the targets, and these detections may be referred to as false detections. No matter the source, these RGB values may be normalized values. This data may be set aside for later retrieval and comparative analysis, as will be explained below. A detection process may be performed with respect to the detections. Because this detection process focuses on the detections in their entireties, these detections may be referred to as full-body detections. Some of the full-body detections may correspond to the targets in a monitoring area 200, but other full-body detections may result from false detections.

In one embodiment, to estimate detection data related to the full-body detections, the processor 110 may convert the RGB frame into a binary format, which can produce binary representations of the full-body detections. To do so, the processor 110 may initially transform the RGB frame into the hue-saturation-value (HSV) domain, thereby creating a hue (H) image, a saturation (S) image, and a value (V) image. Following the transformation, the processor 110 may focus on the S and V images and can throw out or ignore the H image. Binary images corresponding to the targets may be segmented out from the S and V images based on their pixel values in relation to a probability-density function (PDF). In particular, those pixels with pronounced values on either side of a median value of the relevant PDF, because they may be pixels related to the targets, may be assigned a binary one. Conversely, those pixels with lower values on either side may be considered background pixels and may be assigned a binary zero. These pixels may be associated with background clutter.

In one case, a constant threshold may be set for one or both sides of the median value of the S and V images to identify cutoff values for determining whether a pixel should be assigned a binary one or zero. Once the binary images are realized for the V and S images, a logical OR operation may be applied to the two images to form composite binary images that represent the targets. The composite binary images may be composed of pixels with binary-one or binary-zero values, with, for example, the binary-one values realized from either the V or S image.

As another option, the binary images may be realized by fusing the V image with a motion-vector image, instead of with an S image. In such a case, a logical AND operation may be applied to the V and motion-vector images to form the composite binary images that represent the targets. Using the V and motion-vector images may reduce the false-detection rate. This type of fusion may be particularly useful for targets that are in motion during the estimation process. If a target is stationary, however, the V and S images may be used to produce the composite binary images, as explained above.

To help control deviations and false detections, the processor 110 may perform morphological filtering on the composite binary images. As an example, the morphological filtering can include the operations of dilation, erosion, and opening. These operations can remove smaller full-body detections or bridge them with larger detections to prevent them from appearing as false detections. In addition, as an option, certain values or thresholds may be adjusted for the morphological filtering. For example, the pixel dimensions of the vertical vectors associated with the dilation, erosion, and opening operations may be changed. In addition, the constant thresholds for the V and S (and motion-vector) images may be modified, and if necessary, adaptive thresholds may be employed to account for the motion of the targets, particularly in the case of movement closer to the camera 102. Additional information on morphological filtering and other related concepts can be found in, for example, the Chen Publication.

Following the morphological filtering, the processor 110 can execute a detection process in which the processor 110 generates one or more detection fields for each of the composite binary images. As an example, the detection fields can define certain values or parameters based on the grouping of pixels that define each of the composite binary images. Additionally, the detection fields may be part of a data structure attached to or part of a full-body detection, and the data structure can be referred to as detection data. In view of the link between a full-body detection and a composite binary image, the detection data may define certain parameters and values of the full-body detections and, hence, the corresponding targets. Although the description here focuses on full-body detections related to human targets, detection data may (in some cases) be generated for full-body detections that are unrelated to human targets, including those from false detections.

Referring to FIG. 4, an example of an RGB frame 400 that shows full-body detections 405 related to several targets is presented. The RGB frame 400 illustrated here is primarily intended to provide a visual realm to assist in the explanation of the detection data that may be estimated for the targets. For example, in relation to the full-body detections 405 of each target and based on the composite binary images described above, the processor 110 may estimate the X and Y positions of a centroid 415 and X and Y positions for the four corners of a bounding box 420. The X and Y positions of the centroid 415 may be used to establish the position of the corresponding target in the monitoring area 200. The processor 110 may also determine an X span and a Y span for the targets. The X span may provide the number of pixels spanning across the horizontal portion of a target, and the Y span may do the same for the vertical portion of the target.

As another example, the processor 110 may estimate a size, height-to-width (HWR) ratio (or length-to-width (LWR) ratio), and deviation from a rectangular shape for the targets. (These estimates may correspond to the number of pixels related to the full-body detections 405.) The deviation from a rectangular shape can provide an indication as to how much the grouping of pixels deviates from a rectangular shape. The detection fields may also include the X and Y positioning of pixels associated with the target. As an example, the X and Y positioning of all the pixels associated with the target (i.e., the entire full-body detection 405) may be part of the detection data. As an option, the X and Y positioning of one or more subsets of pixels of all the pixels associated with the target may be part of the detection data.

The detection data may include other data in addition to the detection fields, and the number and type of detection fields are not necessarily limited to the examples shown here. For example, one or more track fields may be calculated and may be part of the detection data. This data may be related to a track for a full-body detection 405, which may indicate the movement of a target, and can be obtained from an analysis of one or more previous frames. Examples of track fields include the change in the X and Y positions of the centroid 415, the velocity of the target, the number of the current frame of the track, and the predicted X and Y positions of the centroid 415 in the next frame. The detection data is not necessarily limited to the number and type of track fields recited here.

The full-body detections 405 visually represented in FIG. 4 may also be referred to as full-body segmentations 425. In this context, a full-body segmentation 425 may represent a group of pixels that are part of the RGB frame 400 that have been effectively isolated from the other pixels of the frame 400. In addition, this grouping of pixels may correspond to a target. Such a segmentation is referred to as a full-body segmentation 425 because it may correspond to the entire body of a target (or some other object in its entirety). The detection data described above may also apply to a full-body segmentation 425. As will be shown below, a full-body segmentation 425 may be further decomposed into one or more body parts.

Referring once again to FIG. 3, once the detection data is estimated, a track-start-point (TSP) analysis may be performed, as shown at step 310. As part of this analysis, the processor 110 may determine whether to assign a starting point, or TSP, for a track of a target with respect to the frame 400. As explained in the '941 application, the processor 110 may compare at least some part of the detection data associated with the targets with the layout of the monitoring area 200 or with data from other frames for this determination. Based on this comparison, the processor 110 may assign TSPs to the tracks corresponding to one or more of the targets and may determine that the tracks associated with other targets have already been designated with TSPs. As a TSP may set the beginning of a track corresponding to a target, the TSP can facilitate the tracking of the target.

In one arrangement, following the TSP analysis, a color-vector-extraction process may be conducted, as shown at step 315. As an example, this extraction may focus on the targets that recently had their TSPs assigned. (The color-vector-extraction step may not be necessary to perform with respect to the targets with tracks that have already had their TSPs assigned, although the extraction and TSP processes may be performed for one or more of the targets (including all of them) for every frame or some interval of frames, such as in response to some event, like a change in the light-source spectrum). This extraction step can enable the processor 110 to estimate multiple reference color vectors, which it can use to segment out several body parts from a full-body segmentation 425. As an example, based on the detection data, the processor 110 may estimate several body parts associated with the full-body segmentations 425 and, hence, the targets. For example, because the detection data may include the X and Y positioning of the pixels related to the targets, the processor 110 may use a portion of the positioning data as a mask and conduct a logical AND operation between the portion of the positioning data and the original RGB frame, or RGB frame 400. From this operation, RGB values related to certain pixels may be extracted. (The RGB values may correspond to color vectors.) The processor 110 may estimate reference color vectors from the extracted RGB pixel values, which may be normalized, for the targets. In this case, the pixels that have their RGB values extracted may be related to different body parts of the targets, and the reference color vectors may be preliminary reference color vectors.

For example, the pixels that serve as the basis for the extraction of the RGB values here may be related to certain areas of a full-body segmentation 425. In one arrangement, this subset of pixels may be identified by reference to one or more detection fields of the detection data. For example, the processor 110 may designate pixels related to a full-body segmentation 425 for the extraction based on their relation to the centroid 415 and the X and Y spans. In this example, the designated pixels may be situated above the centroid 415 and within certain ranges of the X and Y spans such that the pixels define an approximate upper-body area of the full-body segmentation 425. The processor 110 may estimate other areas of the full-body segmentation 425 for acquiring the relevant RGB values, such as a lower-body area and a head area. The lower-body area may be positioned below the centroid 415, and the head area may be located above the centroid 415, with both area being within a certain range of the X and Y spans.

From the extracted RGB values, the processor 110 may estimate a preliminary median RGB value for the relevant areas of the full-body segmentation 425. Based on these preliminary median RGB values, the processor 110 may estimate multiple reference color vectors. In one embodiment, a reference color vector may be estimated for each of the approximated areas of the full-body segmentation 425. A preliminary reference color vector may have a direction and a length, and the direction may define a preliminary reference spectral angle. In view of this arrangement, a preliminary reference color vector may be related to the color of the portion of a target from which it originates. For example, if a target is wearing a blue shirt, the preliminary reference color vector associated with the upper-body area of the full-body segmentation 425 may be at least substantially based on that particular color. Because multiple areas of the full-body segmentation 425 are involved, a plurality of preliminary reference spectral angles may be realized. Although the extraction of the RGB pixel values is described at this stage, it may occur earlier, such as during the initial detection process presented above.

In one embodiment, the processor 110 may be configured with a spectral angle mapper (SAM) solution. The SAM solution can be used to determine the spectral similarity between two spectra by calculating the angle between the spectra and treating them as vectors in a space with dimensionality equal to the number of spectral bands. The spectral angle between similar spectra is small, meaning the wavelengths of the spectra and, hence, the color associated with them are alike. Thus, a reference spectral angle, like the preliminary reference spectral angle, may be useful for segmenting out part of a full-body segmentation 425 in terms of color similarity among the pixels associated with the full-body segmentation 425.

Once the preliminary reference color vectors are estimated, the processor 110 may use the X and Y positioning of all or a substantial portion of the pixels associated with a full-body segmentation 425 as a mask to extract RGB values from the original RGB image. The processor 110 may then compare the spectral angles of the pixels associated with the full-body segmentations 425 with the multiple preliminary reference spectral angles. The spectral angles of the pixels that are associated with the full-body segmentation 425 that match a preliminary reference spectral angle may define a refined area of the full-body segmentation 425, which can be segmented out from the full-body segmentation 425. This area is referred to as a “refined area” because the accuracy of the SAM solution enables the area to be more precisely defined.

In addition, to be a match, a spectral angle of an extracted pixel value may be identical to the preliminary reference spectral angle or may fall within a range that includes the preliminary skin-reference spectral angle. The range may be defined by one or more preliminary reference spectral angle thresholds. Because multiple preliminary reference spectral angles are involved, several refined areas may be segmented out from the full-body segmentation 425 in accordance with this description. These refined areas may correspond to certain parts of a target, such as an upper-body or lower-body area. The spectral angles of the extracted pixel values that do not match (either not identical or outside the reference spectral angle threshold(s)) a preliminary reference spectral angle may not correspond to the refined area that is segmented out and arises from that preliminary reference spectral angle.

The processor 110 may be configured to determine second median RGB values from the refined areas that are segmented out from the full-body segmentation 425. For example, a second median RGB value may be estimated for each of the segmented-out (refined) areas. Based on the second median RGB values, the processor 110 may estimate several refined reference color vectors, from which refined reference spectral angles may be obtained. The term “refined” indicates that, because a second median RGB value originates from a segmented-out (refined) area (as opposed to one estimated from detection data), this additional reference spectral angle may be a more accurate indicator of the actual color of the relevant part of the target in comparison to the preliminary reference spectral angle. For brevity, however, a refined reference color vector and a refined reference spectral angle may be respectively referred to as a reference color vector and a reference spectral angle. Examples of the application of reference spectral angles will be shown below.

In some cases, one or more thresholds can be estimated for a reference spectral angle. Similar to a preliminary reference spectral angle threshold, the threshold for a reference spectral angle can serve as a cut-off value for determining whether the spectral angles of the pixels match the reference spectral angle. For example, as will be shown later, the processor 110 can be configured to segment out body parts when the spectral angles of the pixels corresponding to the body parts fall within the threshold for the reference spectral angle. To fall within the threshold for the reference spectral angle, the spectral angles may equal the value of the reference spectral angle, be below or above such value, or equal and be below or above such value. The value for the threshold of a reference spectral angle can be estimated in several ways. For example, the processor 110 may select a predetermined value based on the second median RGB value or may calculate it based on the second median RGB value and other suitable factors, such as lighting conditions or the configuration of the monitoring area 200. As an option, these thresholds may be adaptive, meaning they could be modified depending on certain conditions, like changes in lighting or a relevant target moving closer or farther away from the camera 102. These principles may also apply to the preliminary reference spectral angle thresholds described above.

In one embodiment, estimating refined reference color vectors once the preliminary reference color vectors are obtained may not be necessary. In such a case, the preliminary reference color vectors may effectively serve as the refined reference color vectors to be used, as will be shown later, for segmenting out multiple body parts. Accordingly, the preliminary reference color vectors and the preliminary reference spectral angles may be respectively referred to as the reference color vectors and the reference spectral angles in this scenario. Likewise, a preliminary reference spectral angle threshold in this instance may be referred to as the threshold for the reference spectral angle. Because the step of estimating the refined reference color vectors may be skipped, estimating the reference spectral angles may be performed faster.

Whether to omit the step of estimating refined reference color vectors may depend on the robustness of the preliminary reference spectral angles. Several factors may contribute to such robustness. For example, certain parts of a target may be inherently suited for effective segmentations. In addition, the accuracy of estimating the preliminary reference color vector may be increased. For example, the composite binary image of a target may be over-segmented, meaning that some parts of the image are not actually related to the target, and adjustments can be made to account for the excessive segmentation. The filter parameters used during the morphological filtering may lead to some pixels unrelated to the target to be used to determine a preliminary median RGB value. As such, a certain fraction or ratio in comparison to the filter parameters may be used to more accurately identify the pixels that are actually related to the target. (In many cases, the filter parameters are in numbers of pixels.) These and other adjustments may be carried out manually or by the use of AI software.

As an option, some of the reference color vectors that are estimated may be based on human skin, and the processor 110 can use these skin reference color vectors to detect and segment out sections of skin related to the targets. For example, the processor 110 can retrieve different skin reference color vectors, which may have already been estimated based on previous extraction sessions with human testing subjects. (Alternatively, the skin reference color vectors, like the other reference color vectors, may also be dynamically estimated from the current targets.) One of the skin reference color vectors may be based on light skin, which may be referred to as a light-skin reference color vector. This light-skin reference color vector may include a light-skin reference spectral angle, which can have a light-skin threshold. As part of the extraction session, a group of human subjects with light skin may serve as the foundation for estimating the light-skin reference spectral angle. Another of the skin reference color vectors can be a dark-skin reference color vector, which may have a dark-skin threshold. A group of human subjects with dark skin may be relied on to generate the dark-skin reference spectral angle. Both the light-skin and dark-skin thresholds may be constant values, and they can be equal to or different from one another. As another option, one or both of the light-skin and dark-skin thresholds may be adaptive in nature. Skin color may be classified as light or dark skin based on its reflectance signature or other criteria, such as the Fitzpatrick scale. Additional information on the use of skin reference spectral angles can be found in U.S. patent application Ser. No. 15/655,019, filed on Jul. 20, 2017, which is herein incorporated by reference.

As an example, the light-skin spectral angle (and its threshold) may be useful for segmenting out skin parts from the targets with light skin, and the dark-skin spectral angle (and its threshold) may facilitate the segmentation of skin parts from those with dark skin. As will be shown later, the ability to segment out skin can enable a processor 110 to decompose a body part into smaller portions, such as a head into a face part and a hair part. Moreover, this feature can enable the processor 110 to estimate reference spectral angles for these additional parts. For example, referring to the face and hair parts, the processor 110 could subtract out or discard the pixels of the head of a full-body segmentation 425 with RGB values that are similar to the relevant skin reference spectral angle. Because the remaining pixels may be part of the head, their RGB values can be used to estimate a reference spectral angle for a hair part of the full-body segmentation 425. This feature may be applied to any of the other areas of the full-body segmentation 425 to facilitate the estimation of the reference spectral angles. Further, a skin reference spectral angle may be particularly suited for this step because it may have been estimated and retrieved prior to the color-vector-extraction process described here.

As can be seen, multiple reference spectral angles corresponding to different parts of a full-body segmentation 425 (and hence, a human target) may be estimated. Examples of them include upper-body, lower-body, skin, and hair reference spectral angles, although other reference spectral angles may be realized from other portions of a full-body segmentation 425, depending on the type of granularity that is wanted.

Returning to FIG. 3, at step 320, at least some of the reference spectral angles may be compared to one another, and based on the comparison, one or more of the reference spectral angles can be discounted (or ignored) for segmenting out body parts, as shown at step 325. For example, each reference spectral angle may have a value, which can be normalized, and the processor 110 can compare these values to one another. As an option, if the value of a first reference spectral angle is within a predetermined threshold of the value of a second reference spectral angle, the use of the first reference spectral angle for segmentation of its corresponding body part may be bypassed or otherwise avoided. (The comparison may be based on the absolute difference between the two values.) As such, in this example, the second reference spectral angle may be considered a preferred reference spectral angle.

As an example, assume a human is wearing a uniform that has a single color, or at least a dominant color (greater than 85-90% of the pixels associated with the uniform). In this instance, the value of the reference spectral angle associated with the upper body may be similar to that of the lower body. As an option, the processor 110 may compare these values and determine to avoid the use of the reference spectral angle of one of these parts. Eliminating a reference spectral angle for segmentation purposes may reduce the computational complexities of the system 100 and improve its accuracy. In one embodiment, if the similarity exists between the values of the reference spectral angles associated with the upper and lower portions of the human, the processor 110 can be configured to discount the use of the reference spectral angle of the upper portion. In many cases, the lower portion of a human's clothing is more uniform in color in comparison to that of the upper portion. (The possibility that a shirt or blouse has certain stripes or other patterns mixed in with, for example, a dominant color is greater than the chances that a pair of pants will exhibit a similar design.) Because the lower portion may present a more even color distribution, the segmentation of its corresponding body part may be more robust than that of the upper portion, thereby increasing the precision of the system 100.

In one embodiment, the predetermined threshold for determining whether to discount the use of a first reference spectral angle may be ten percent or up to twenty percent of the value of a second (and preferred) reference spectral angle. This concept is not limited to comparisons between upper- and lower-body parts, as other combinations (including more than two parts) may be considered.

No matter the number and type of reference color vectors that are estimated from a full-body segmentation 425, the reference spectral angles can be assigned to a track for the corresponding target. As explained above, a TSP can designate the start of the track for a target that may be passively tracked. As will be shown below, the processor 110 can progressively build this track based on the detections in future frames that may ultimately match the reference spectral angles attached to the track.

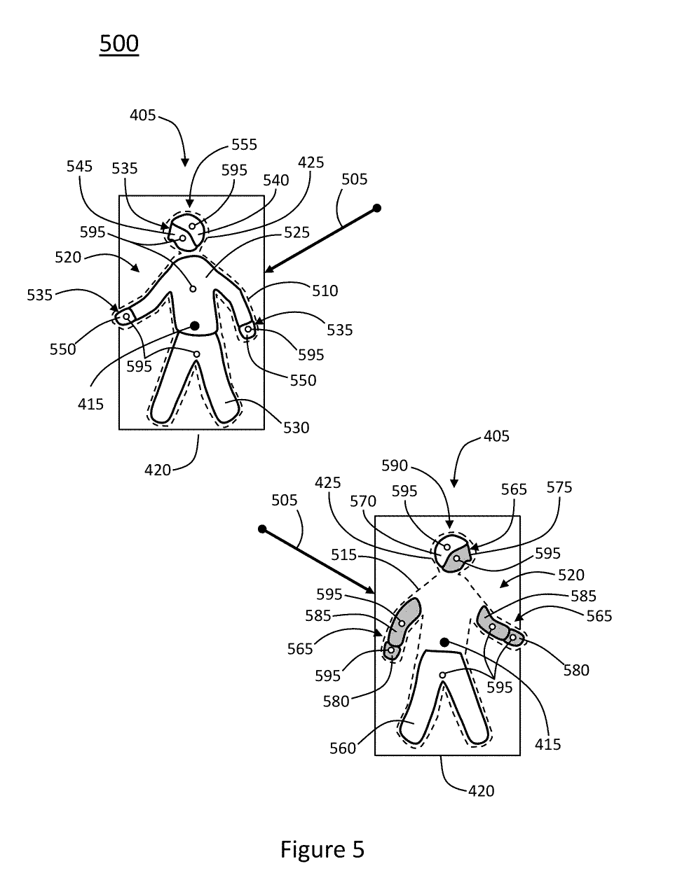

Moving back to FIG. 3, at step 330, one or more full-body segmentations associated with one or more objects of a future frame may be realized. In addition, at step 335, multiple body parts may be segmented out from the full-body segmentations. To help explain this step, reference will be made to FIG. 5, which illustrates several full-body segmentations 425 with dashed outlines (and centroids 415 and bounding boxes 420) that are part of an RGB frame 500. In this example, the objects are human targets with tracks 505 that have already been assigned their TSPs. To assist in this explanation, the full-body segmentations 425 may be individually referred to as a full-body segmentation 510 and a full-body segmentation 515. The full-body segmentations 425, including their detection data, can be realized in accordance with the steps described above. Here, however, an example of the process of segmenting out (multiple) different body parts from both of the full-body segmentations 425 will be presented.

As part of segmenting out the different body parts, the processor 110 may use the full-body segmentations 425 as a mask to obtain the RGB values from the pixels of the RGB frame 500 that correspond to the full-body segmentations 425. The processor 110 may then compare the spectral angles of these pixels with the various reference spectral angles that were previously estimated. The pixels with spectral angles that match a particular reference spectral angle may be segmented out from the relevant full-body segmentation 425 as one or more body parts.

For example, the reference spectral angles associated with the full-body segmentation 510 may result in multiple body parts 520 being segmented out of the full-body segmentation 510. The body parts 520 are shown superimposed on the full-body segmentations 425, with solid outlines to help distinguish them from the full-body segmentations 425. In this example, the reference spectral angles attached to the track 505 for this full-body segmentation 510 may be upper-body, lower-body, light-skin, and hair reference spectral angles. Accordingly, an upper-body part 525, a lower-body part 530, light-skin parts 535, and a hair part 540 may be segmented out from the full-body segmentation 510. As an example, the light-skin parts 535 may include a face part 545 and hand parts 550, and the face part 545 may contain pixels that correspond to the face, neck, and ears of the relevant human target. In addition, the face part 545 and the hair part 540 may correspond to the head of the target. As an option, the face part 545 and the hair part 540, even though they may be isolated from one another based on their associated spectral angles, may be treated as an entire body part, such as a head part 555. Although the hair part 540 is typically associated with the hair on the head of a target, other hair may be segmented out, such as facial hair.

An upper-body part may be a body part that is defined by at least a majority of its associated pixels being positioned above the Y position of the centroid 415 of the full-body segmentation 425. In contrast, a lower-body part may be a body part that is defined by at least a majority of its associated pixels being positioned below the centroid 415. The positioning of the pixels corresponding to an upper-body part and a lower-body part with respect to other reference points, such as the X positioning of the centroid 415 or the X and Y spans of the full-body segmentation 425, may assist in defining the upper- and lower-body parts. How the pixels corresponding to other body parts 520 are positioned with respect to such reference points may also facilitate the defining of these other parts 520. For example, a face part or a hair part may be defined by all its associated pixels being above the centroid 415 by at least a certain amount of pixels and within a certain horizontal range (in pixels) of the X position of the centroid 415.

As another example, the reference spectral angles associated with the full-body segmentation 515 may result in several body parts 520 being segmented out from the full-body segmentation 515, such as a lower-body part 560, dark-skin parts 565, and a hair part 570. In this instance, the dark-skin parts 565 may include a face part 575, hand parts 580, and arm parts 585, and, like the example above, the face part 575 and the hair part 570 may be treated as a head part 590. Here, the arm parts 585 may have been segmented out because the human target corresponding to the full-body segmentation 515 may be wearing a short-sleeve shirt. (The target corresponding to the full-body segmentation 510 may be wearing a shirt with long sleeves.) In addition, no upper-body part was segmented out, which may be because the value of its reference spectral angle was within the threshold for that of the reference spectral angle of the lower-body part 560.

Referring back to FIG. 3, at step 340, detection data associated with the body parts that are segmented out can be obtained, and at step 345, it can be determined whether the body parts are related to one another. For example, such detection data can be similar to that estimated for the full-body segmentations 425 (or full-body detections 405), meaning it can include all or a portion of the detection fields that are generated for the full-body segmentations 425. For example, the processor 110 can estimate a centroid 595 for each of the segmented-out body parts 520, in addition to their sizes, X and Y spans, height-to-width or length-to-width ratios (respectively, HWR and LWR), deviation from a rectangular shape, and the X and Y positioning of their pixels. If enough processing power is available, the processor 110 may also estimate one or more track fields as part of the detection data. (The information provided by the track fields may be similar to the examples presented above with respect to the full-body segmentations 425 (or full-body detections 405.))

In one arrangement, the detection data can be used to determine whether certain body parts 520 are related to one another, meaning they correspond to or originate from the same full-body segmentation 425 or some other common element. For example, referring to the full-body segmentation 510 of FIG. 5, the processor 110 can compare the X positions of the centroids 595 for the upper-body part 525, lower-body part 530, light-skin parts 535, and hair part 540 to one another. When the X positions of the centroids 595 of these body parts 520 are within a certain range of pixels of one another, the processor 110 may determine that they are related. To facilitate such comparisons, the processor 110 may designate at least one of the centroids 595 to serve as a reference centroid, such as that of the upper-body part 525. In such an example, the range of pixels for determining whether body parts are related may be tied to the reference centroid. The body parts 520 with centroids 595 with X positions outside the range may be considered unrelated to those with centroids 595 within the range, meaning they may originate from another full-body segmentation 425 or are false detections.

This concept may apply to any body part 520, including, for example, those that make up the light-skin parts 535, such as the face part 545 and the hand parts 550, of any full-body segmentation 425. Moreover, other parameters, in addition to or in lieu of the X positions, may be considered when determining whether body parts 520 are related to one another. An example of such a parameter is a Y position of the relevant centroid 595.

Turning back to FIG. 3, at step 350, the body parts may be classified in accordance with a classification scheme. In particular, the processor 110 may analyze the detection data of the body parts 520 and classify at least some of them based on comparing the detection data with one or more sets of reference detection fields. As an example, a set of reference detection fields may be detection fields that are estimated for an average body part, which can be based on previous segmentations of multiple targets acting as test subjects. A classification scheme may include multiple categories of body parts that correspond to various sets of the reference detection fields. Thus, when the actual detection data is compared to and matches or substantially matches a set of reference detection fields, the body part 520 can be classified in accordance with the relevant category. In some cases, the body parts 520 may be annotated with such designations, which can facilitate their identification when necessary.

As an example, the processor 110 may classify the lower-body part 530 of the full-body segmentation 510 as a pair of legs or long pants based on comparing the number of pixels it contains, the X and Y positions of its pixels or its centroid (or both), its HWR or LWR (or both), or its deviation from a rectangular shape with the reference data. As another example, relying on a similar process, the processor 110 may classify a light-skin part 535 as a face part 545 or a hand part 550. As an option, the classifications can be made more or less granular. For example, the classification of a body part 520 can be narrowed down to certain orientations or perspectives, such as categorizing the lower-body part 530 as a front or back lower-body part (with respect to the camera 102) or right and left leg parts.

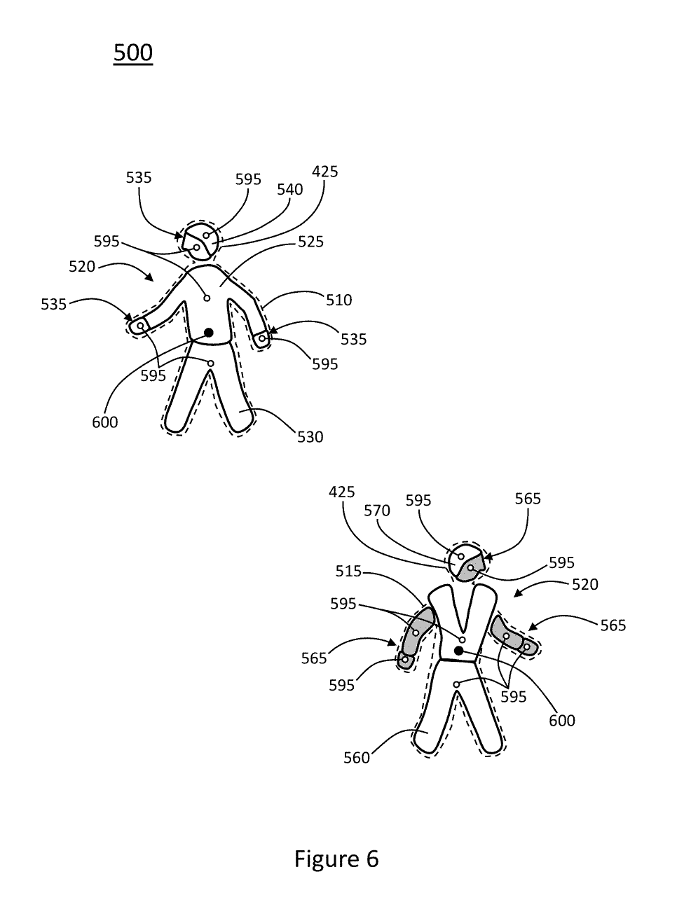

Returning once again to FIG. 3, at step 355, a virtual centroid for the full-body segmentation can be estimated, and the targets can be tracked based on the virtual centroids, as shown at step 360. To assist in explaining these steps, reference will be made to FIG. 6, which shows the full-body segmentations 425 and body parts 520 of the RGB frame 500 from FIG. 5.

In one embodiment, the processor 110 may rely on the centroids 595 of the body parts 520 associated with a full-body segmentation 425 to estimate a virtual centroid 600 for that full-body segmentation 425. For example, the processor 110 can estimate a virtual centroid 600 for the full-body segmentation 510 from the centroids 595 of the upper-body part 525, lower-body part 530, light-skin parts 535, and hair part 540. Likewise, the processor 110 may estimate a virtual centroid 600 for the full-body segmentation 515 from the centroids 595 of the lower-body part 560, dark-skin parts 565, and hair part 570. The term “virtual” is used here because the centroid 600 may be based on the positioning of the centroids 595 of the relevant body parts 520, as opposed to the detection data of the full-body segmentation 425. Once the virtual centroids 600 are estimated, the processor 110 may rely on them to continue tracking the corresponding targets. For example, the X and Y positions of the virtual centroids 600 can be used to update the tracks 505 of the full-body segmentations 425 with respect to the frame 500 (see FIG. 5).

Using the centroids 595 of all the body parts 520 associated with a full-body segmentation 425 may not be necessary to estimate a virtual centroid 600 for that full-body segmentation 425. For example, the processor 110 may simply rely on the centroids 595 of the upper-body part 525 and the lower-body part 530 to estimate the virtual centroid 600 for the full-body segmentation 510. As such, the centroids 595 of any combination of the segmented-out body parts 520 may be relied on for this purpose.

In addition, in some cases, a body part 520 may emulate another body part 520 to facilitate the estimation of a virtual centroid 600. Referring to the full-body segmentation 515, recall the body parts 520 segmented out from it include the lower-body part 560, dark-skin parts 565, and hair part 570, although no upper-body part was realized because the value of its reference spectral angle was too similar to that of the lower-body part 560. In this example, the processor 110 can generate a substitute body part 605 in place of an upper-body part by inverting the lower-body part 560. As part of this step, the processor 110 may also estimate detection data for the substitute body part 605, and as an option, its centroid 595 may be relied on to estimate the virtual centroid 600 of the full-body segmentation 515. Different body parts 520 may be used as substitutes for the missing upper-body part or any other body part 520 that is unavailable for estimating the virtual centroid 600. As another alternative, no emulation may be necessary, as the virtual centroid 600 may be estimated based on the centroid 595 from the available body parts 520.

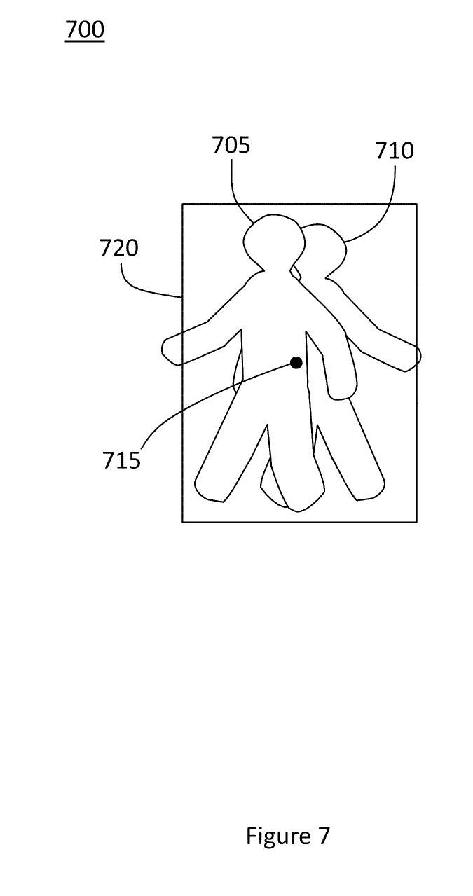

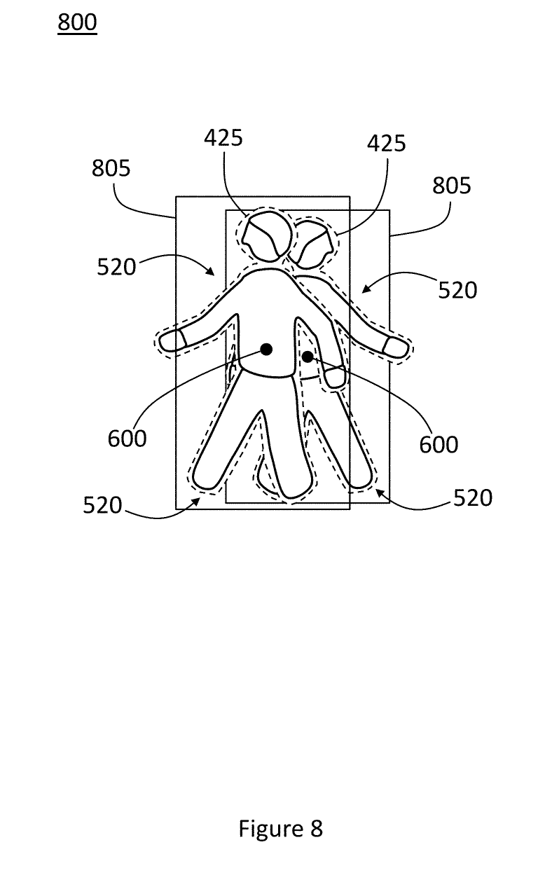

As noted above, a target can be tracked based on its corresponding virtual centroid 600. As new frames are created, the process of realizing full-body segmentations 425, segmenting out the body parts 520, and estimating the virtual centroids 600 may be repeated, such as for every frame or every n^{th} frame. Tracking targets based on virtual centroids 600 may be useful, particularly in monitoring areas 200 with multiple targets, because the centroids 600 may be unaffected when the targets are close to one another. Reference will be made to FIGS. 7 and 8 to help explain this advantage.

In FIG. 7, an RGB frame 700 shows two full-body detections 705 and 710 that represent two different targets in which one of the targets has moved in front of the other. In conventional systems, the full-body detections 705 and 710 are effectively merged and are treated as a single detection with a single centroid 715 and bounding box 720. This effect will create a break in the tracking of one or both of the targets.

Referring to FIG. 8, an RGB frame 800 shows two full-body segmentations 425 (with dashed outlines) and multiple body parts 520 (with solid boundaries) that represent two different targets. The targets here are in the same orientation as those of FIG. 7. As can be seen, a virtual centroid 600 and a bounding box 805 have been estimated for both of the full-body segmentations 425. Thus, even when the targets overlap, the system 100 may still be able to track both targets simultaneously. This feature becomes more advantageous as the number of targets in a monitoring area 200 increases.

In some cases, the solutions presented here may be applicable for pre-existing images, in addition to those that are generated by the system 100. For example, the system 100, through its communication circuit 120, can retrieve such images from a database and can use the principles presented here to further process them. In this arrangement, a camera may not be a required component for the system 100, as the images are already in existence.

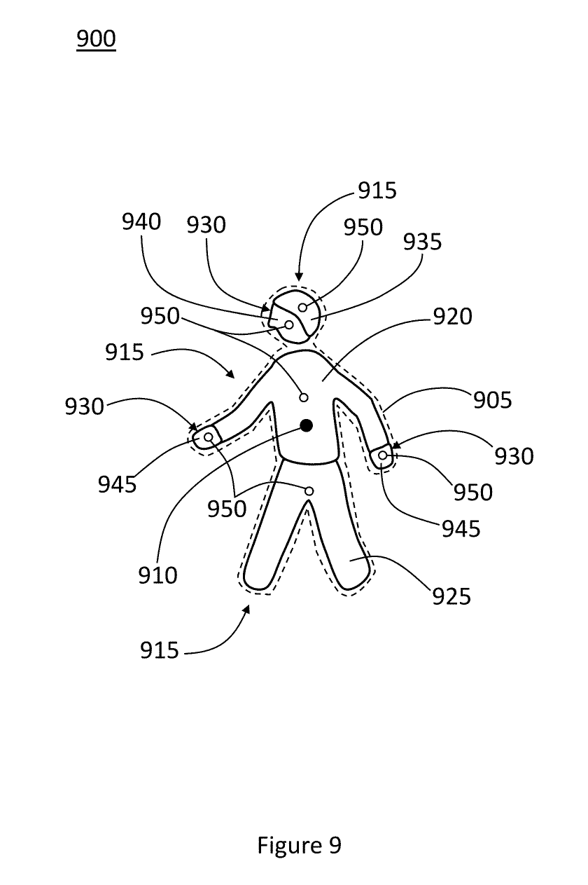

Some of the images may include full-body segmentations that identify certain objects in them. For instance, referring to FIG. 9, an image 900 with a full-body segmentation 905 that represents a person that is part of the image 900 is shown, and the image 900 may be retrieved from the database. In this example, the image 900 can be an RGB image, and the full-body segmentation 905 was created by a human worker manually identifying pixels that form the person in the image 900. This manual process is far more time consuming (and expensive) than the automated process of realizing the full-body segmentations 425 illustrated above. In addition, the full-body segmentations 425, because the process relies on human input, does not always accurately segment out the relevant object. Moreover, decomposing the full-body segmentation 905 into one or more body parts, up to this point, would have to be performed manually, which would be even more tedious than creating the full-body segmentation 905.

The system 100, however, can automate this process by analyzing the image 900 to digitally detect color differences of the full-body segmentation 905 and segmenting out one or more body parts from the full-body segmentation 905 based on the detected color differences. To do so, the system 100 may rely on many of the concepts that were previously described. For example, the processor 110 can estimate detection data for the full-body segmentation 905, which may include at least some of the detection fields presented above. (Because the image 900 may be a stationary image, the detection data may not include the track fields, which are related to motion.) At least one of the detection fields can include the X and Y positions of a full-body centroid 910. From the detection fields, the processor 110 may identify several preliminary body parts (not shown).

From these preliminary body parts, the processor 110 may estimate several preliminary reference spectral angles, which can be used to extract pixel values for obtaining multiple refined reference spectral angles. The estimation of the preliminary and refined reference spectral angles can be in accordance with the description provided above. Further, like the examples illustrated earlier, the step of estimating two different sets of reference spectral angles (preliminary and refined) can be simplified such that only one set of them (refined) is necessary. In either case, a reference spectral angle, in this process, may also be referred to as an estimated spectral angle, as it is estimated from the pixel values associated with the full-body segmentation 905.

The reference spectral angles can then be used to segment out multiple body parts 915 (shown with dashed outlines) from the full-body segmentation 905. Like the solutions presented earlier, the reference or estimated spectral angles can be compared with spectral angles that are extracted from the full-body segmentation 905 (sometimes referred to as extracted spectral angles). As an example, the body parts 915 that are segmented out here can include an upper-body part 920, a lower-body part 925, light-skin parts 930, and a hair part 935. As another example, the light-skin parts 930 may include a face part 940 and hand parts 945, each of which may be independent segmentations. The processor 110 can also estimate detection data for the body parts 915 that are segmented out from the full-body segmentation 905, which can be similar to that of the body parts 520 discussed in relation to FIG. 5. As part of the detection data, the processor 110 can estimate body-part centroids 950 for the body parts 915, either all of them or at least some of them. In view of the detection data of the body parts 915, the processor 110 may also confirm the body parts 915 are related and can classify them. As such, a pre-existing image that already includes a full-body segmentation can be further decomposed into multiple body parts, and (based on the classification) the body parts can be attached or annotated with some form of identifying data. This process can be quickly repeated for thousands of such images, including for full-body segmentations of non-human objects, like animals, machines, or buildings.

If desired, the processor 110, based on one or more of the body-part centroids 950, can estimate a virtual centroid 955 for the full-body segmentation 905. If necessary, substitute body parts may be relied on for this estimation if any of the body parts 915 are unavailable, such as if the reference spectral angles for two separate body parts 915 are too similar.

In one embodiment, the pre-existing images may be part of a dataset that is used to train artificial intelligence (AI) systems. As is commonly known, large amounts of data are required to train these systems, and such a dataset may contain thousands of images. Through the concepts introduced here, the body parts that are segmented out (with estimations of detection data) and classified can provide a substantial increase in the availability of objects in the images of these datasets for such training, with any additional expenses and time kept to a minimum. In addition to contributing to AI-based systems, the processes, algorithms, systems, and solutions presented herein may rely on various AI models or comparable software to improve their operational performance.

Advances in computer-vision technology have led to solutions that can estimate two-dimensional (2D) poses for humans in an image. Some pose-estimation systems rely on datasets, like the one mentioned above, with thousands of images containing pre-existing full-body segmentations for training purposes. As an example, the application of virtual centroids to these segmentations may enable these systems to provide more accurate pose estimations, especially if some of the full-body segmentations overlap one another. Moreover, this type of system may be able to estimate 2D poses for the body parts that have been segmented out from the full-body segmentations, which may represent a significant increase in the granularity of the system. For example, a 2D pose may be estimated for a human hand that has been segmented out (along with the generation of its detection data), such as whether the hand is open or clenched into a fist.

Although the solutions described herein primarily focus on indoor settings, the system 100 can operate in areas that are not enclosed or sheltered. For example, the system 100 may be positioned in areas that are exposed to the environment, such as open locations in amusement parks, zoos, nature preserves, parking lots, docks, or stadiums. Environmental features, like sunlight patterns, foliage, snow accumulations, or water pooling, may be eliminated as background clutter. Moreover, even though the description herein focuses primarily on humans as targets, the principles described herein may apply to other objects from which full-body segmentations and segmented-out body parts may be realized. For example, a full-body segmentation of a machine may be realized, and body parts associated with the machine, such as panels, supports, displays, glass, bumpers, tires, or seats, may be segmented out from the full-body segmentation. Additionally, because this solution may rely on a camera, the techniques and processes described herein may be implemented by simply retrofitting existing camera systems.

The flowcharts (if any) and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including wireless or wireline technologies (like optical fiber, cable, RF, etc.) or both. Computer program code for carrying out operations for aspects of the present arrangements may be written in any combination of one or more programming languages, including an object-oriented programming language, such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

What is claimed is:

1. A system for segmenting out multiple body parts of an image, comprising:
an image-sensor circuit configured to generate a frame of a monitoring area that includes data associated with a human target in the monitoring area; and
a processor communicatively coupled to the image-sensor circuit and configured to:
receive the frame from the image-sensor circuit;
compare spectral angles extracted from the frame with multiple reference spectral angles corresponding to different body parts associated with the human target; and
based on the comparison of the spectral angles extracted from the frame with the reference spectral angles, segment out multiple body parts associated with the human target.

2. The system of claim 1, wherein the processor is further configured to estimate one or more detection fields for the body parts that are segmented out, wherein at least one of the detection fields is a body-part centroid.

3. The system of claim 2, wherein the processor is further configured to determine whether the body parts that are segmented out are related to one another.

4. The system of claim 3, wherein the processor is further configured to:
estimate a virtual centroid based on one or more body-part centroids when the body parts that are segmented out are related to one another; and
track the human target based on the virtual centroid.

5. The system of claim 1, wherein the processor is further configured to classify one or more of the body parts that are segmented out in accordance with a classification scheme.

6. The system of claim 1, wherein the processor is further configured to estimate the reference spectral angles corresponding to the different body parts associated with the human target.

7. The system of claim 6, wherein the processor is further configured to:
compare an estimated reference spectral angle corresponding to a first body part with an estimated reference spectral angle corresponding to a second body part; and
when a difference between the reference spectral angle corresponding to the first body part and the reference spectral angle corresponding to the second body part has a value that is below or equal to a threshold, discount the reference spectral angle for the first body part when the processor compares the spectral angles of the frame with the reference spectral angles corresponding to the different body parts associated with the human target.

8. The system of claim 7, wherein the first body part is an upper-body part and the second body part is a lower-body part.

9. The system of claim 7, wherein when the reference spectral angle for the first body part is discounted, the processor is further configured to:
generate a substitute first body part by inverting the second body part; and
estimate a virtual centroid for tracking based at least on a body-part centroid of the second body part and a body-part centroid of the substitute first body part.

10. A segmentation system, comprising:
an image-sensor circuit configured to generate a frame of a monitoring area that includes data associated with an object in the monitoring area; and
a processor communicatively coupled to the image-sensor circuit and configured to:
receive the frame from the image-sensor circuit;
compare spectral angles corresponding to a full-body segmentation of the frame with multiple reference spectral angles corresponding to different parts of the object; and
based on the comparison of the spectral angles corresponding to the full-body segmentation of the frame with the reference spectral angles, segment out multiple parts from the full-body segmentation, wherein the multiple parts that are segmented out and the full-body segmentation are associated with the object.

11. The system of claim 10, wherein the object is a human target and the multiple parts that are segmented out from the full-body segmentation are body parts associated with the human target.

12. The system of claim 11, wherein the body parts that are segmented out from the full-body segmentation include an upper-body part, a lower-body part, a skin part, and a hair part and the processor is further configured to estimate a reference spectral angle for the upper-body part, the lower-body part, the skin part, and the hair part.

13. The system of claim 12, wherein the skin part includes one or more skin parts and wherein the processor is further configured to discard values of pixels associated with at least some of the skin parts when estimating the reference spectral angles for the upper body-part, the lower-body part, or the hair part.

14. The system of claim 12, wherein the processor is further configured to:
compare the reference spectral angle for the upper-body part with the reference spectral angle for the lower-body part; and
when the reference spectral angle for the upper-body part has a value that is below a difference threshold in comparison to a value of the reference spectral angle for the lower-body part, bypass the use of the reference spectral angle for the upper body part for segmenting out body parts from the full-body segmentation.

15. The system of claim 11, wherein the processor is further configured to:
estimate a body-part centroid for the body parts that are segmented out;
estimate a virtual centroid based on the body-part centroids; and
track the human target based on the virtual centroid.

16. A method for decomposing a full-body segmentation into multiple body-part segmentations, comprising:
realizing a full-body segmentation associated with a human target;
comparing spectral angles corresponding to the full-body segmentation with multiple reference spectral angles corresponding to different portions of the human target;
based on comparing the spectral angles corresponding to the full-body segmentation with the multiple reference spectral angles, segmenting out multiple body parts from the full-body segmentation; and
estimating a virtual centroid based on the body parts segmented out from the full-body segmentation.

17. The method of claim 16, further comprising using the virtual centroid to track the human target.

18. The method of claim 16, wherein the body parts segmented out from the full-body segmentation include an upper-body part, a lower-body part, and a hair part and the method further comprises estimating a reference spectral angle for the upper-body part, the lower-body part, and the hair part.

19. The method of claim 18, wherein estimating the virtual centroid based on the body parts segmented out from the full-body segmentation further comprises:
estimating the virtual centroid based on both an upper-body part and a lower-body part; or
estimating the virtual centroid based on both the lower-body part and an inverted lower-body part.

20. The method of claim 19, wherein estimating the virtual centroid based on both the lower-body part and an inverted lower-body part comprises estimating the virtual centroid based on both the lower-body part and the inverted lower-body part when a value for the reference spectral angle for the upper-body part is below a difference threshold in comparison to a value for the reference spectral angle for the lower-body part.
